(19) United States
(12) Patent Application Publication
(10) Pub. No.: US 2024/0418690 A1
(43) Pub. Date: Dec. 19, 2024

(54) DETECTION UNIT FOR GAS SENSOR, GAS SENSOR, SYSTEM FOR DETECTING A PLURALITY OF DIFFERENT TARGET GASES, AND METHOD FOR DETECTING A TARGET GAS

(71) Applicant: Fraunhofer-Gesellschaft Zur Förderung der angewandten Forschung e.V., München (DE)

(72) Inventors: Marie-Luise Bauersfeld, Freiburg (DE); Martin DOLD, Freiburg (DE); André EBERHARDT, Freiburg (DE); Mahmoud EL-SAFOURY, Freiburg (DE); Laura ENGEL, Freiburg (DE); Yvonne HESPOS, Freiburg (DE); Andreas KÜRZINGER, Freiburg (DE); Carolin PANNEK, Freiburg (DE); Sven RADEMACHER, Freiburg (DE); Christian WEBER, Freiburg (DE); Jürgen WÖLLENSTEIN, Freiburg (DE); Ina SEIBERLICH, Freiburg (DE)

(73) Assignee: Fraunhofer-Gesellschaft Zur Förderung der angewandten Forschung e.V., München (DE)

(21) Appl. No.: 18/722,032

(22) PCT Filed: Dec. 20, 2021
(86) PCT No.: PCT/EP2021/086825

§ 371 Date: Jun. 20, 2024

(51) Int. Cl. G01N 31/22; G01N 21/77; G01N 21/78

(52) U.S. Cl. CPC G01N 31/223; G01N 21/783; G01N 2021/7753; G01N 2021/7793; G01N 2021/7796; G01N 2201/0221; G01N 2201/0616

(57) ABSTRACT

A detection unit for a gas sensor, having at least one gas-sensitive element (1) including at least one gas-sensitive material, the optical properties of which vary as a function of the contact with a target gas. The detection unit is configured for arrangement on a mobile evaluation unit (5) having an image acquisition unit (6), in order to form a gas sensor, and the detection unit has at least one optical lens (2), and the gas-sensitive element (1) and the optical lens (2) are arranged in such a way that the ambient light (U) that passes through the gas-sensitive element (1) can be imaged by the optical lens (2), in particular can be imaged onto the image acquisition unit (6) when the detection unit is arranged on the mobile evaluation unit (5).

### CROSS-REFERENCE TO RELATED APPLICATIONS

This application mis a 371 National Phase of International Application No. PCT/EP2022/086825, filed Dec. 20, 2021, which is incorporated herein by reference as if fully set forth.

### TECHNICAL FIELD

The invention relates to a detection unit for a gas sensor, to a gas sensor, to a system for detecting a plurality of different target gases, and to a method for detecting a target gas.

### BACKGROUND

Gas sensors are used to detect and analyze gases. Gas sensors with physical and chemical measurement principles are known. The present invention relates to colorimetric gas sensors, in which a gas-sensitive element comprises at least one gas-sensitive material that varies its optical properties as a function of the contact with a target gas. Such colorimetric gas sensors are used in particular when only a limited energy supply is available and/or the intention is to provide economical sensors.

Colorimetric gas sensors in which the detection of the target gas takes place by means of analyzing ambient light that passes through the gas-sensitive element of gas sensor are known. Such a gas sensor is known from EP 3 783 341 A1.

There is a need for economical gas sensors that can be employed by users who do not have professional access to measuring instruments specially developed for gas sensing technology. Particularly in the private sector, the demand for sensors to monitor environmentally critical and noxious gases is increasing greatly.

### SUMMARY

The object of the present invention is therefore to provide an economical means of gas detection. This object is achieved by a detection unit for a gas sensor, by a gas sensor comprising such a detection unit, by a system for detecting a plurality of different target gases, and by a method for detecting a target gas, each having one or more of the features disclosed herein. Advantageous configurations may be found in in the description and claims that follow.

The detection unit according to the invention, the gas sensor according to the invention and the system according to the invention for detecting a plurality of different target gases are preferably configured to carry out the method according to the invention, in particular a preferred embodiment thereof.

The method according to the invention is preferably configured to be carried out by means of a detection unit according to the invention, by means of a gas sensor according to the invention or by means of a system according to the invention for detecting a plurality of different target gases, in particular by means of preferred embodiments of these apparatuses.

The present invention is based on the discovery that mobile devices comprising an image acquisition unit are very widespread and may be used economically to detect a target gas. In particular, cellphones typically not only have image acquisition units that enable image acquisition with high quality, in particular good color rendering. Such devices furthermore have computer units and data memories that provide sufficient computing power to analyze the image data of the image acquisition unit by means of provided third-party programs (applications, “apps”).

In the present invention, such devices are used and supplemented with a detection unit in order to detect one or more target gases.

The object mentioned in the introduction is therefore achieved by a detection unit having one or more of the features disclosed herein:

The detection unit according to the invention for a gas sensor has at least one gas-sensitive element comprising at least one gas-sensitive material, the optical properties of which vary as a function of the contact with a target gas.

Such gas-sensitive materials are known from the prior art and in particular from EP 3 783 341 A1.

What is essential is that the detection unit is configured for removable arrangement on a mobile evaluation unit comprising an image acquisition unit, in order to form a gas sensor. The image acquisition unit of the mobile evaluation unit is therefore used to analyze ambient light that passes through the gas-sensitive element of the detection unit, and thereby detects a variation of the optical property of the gas-sensitive material and therefore the presence of the target gas.

The detection unit according to the invention comprises at least one optical lens, and the gas-sensitive element and the optical lens are arranged in such a way that ambient light that passes through the gas-sensitive element can be imaged by means of the optical lens. This enables a high-quality analysis of the ambient light that passes through the gas-sensitive element, which is not susceptible to error. The gas-sensitive element and the optical lens are therefore preferably configured in such a way that the ambient light passes through the gas-sensitive element, which is arranged on the mobile evaluation unit, and the information can be imaged onto the image acquisition unit by means of the optical lens.

The optical lens is preferably configured as a converging lens.

The detection unit according to the invention therefore enables economical detection of a target gas since already available mobile devices, for example a cellphone or a tablet computer, are employed as the mobile evaluation unit, and therefore only the detection unit, which preferably does not have any electrical or electronic components, is additionally necessary. Such a detection unit can be produced much more economically compared with previously known gas sensors, so that in combination with the mobile evaluation unit comprising an image acquisition unit, economical detection of a target gas is enabled for private users as well.

The object mentioned in the introduction is therefore likewise achieved by a gas sensor having one or more of the features disclosed herein. The gas sensor has a detection unit according to the invention, in particular an advantageous configuration thereof, and a mobile evaluation unit comprising an image acquisition unit, the mobile acquisition unit being configured as a cellphone or tablet computer.

The image acquisition unit is configured for position-resolved image acquisition, preferably by means of an image acquisition element that is known per se, in particular by means of at least one CCD chip.

The mobile evaluation unit has a computer unit and a memory unit (data memory unit) in order to run programs. In particular, the mobile evaluation unit is configured to run programs in order to evaluate image data that are acquired by means of the image acquisition unit.

This enables the above-described economical gas detection.

The object mentioned in the introduction is likewise achieved by a method having one or more of the features disclosed herein. The method has the following method steps:
A. arranging a detection unit according to the invention, in particular an advantageous configuration, on a mobile evaluation unit (5) comprising an image acquisition unit (6), in particular on a cellphone;
B. analyzing the ambient light that passes through the gas-sensitive element (1) of the detection unit by means of the image acquisition unit (6) in order to detect the target gas;
C. removing the detection unit from the mobile evaluation unit (5).

This provides an economical method for detecting a target gas, which is straightforward for the user.

In one advantageous embodiment of the detection unit, the detection unit comprises a plurality of optical lenses that are arranged in a lens matrix in order to image a two-dimensional region in a plurality of focusing beams, in particular to image a plurality of focusing beams onto a plurality of differently positioned points of the image acquisition unit when the detection unit is arranged on the mobile evaluation unit.

This provides the advantage that a relatively large area can be imaged onto different detection regions of the image acquisition unit.

The detection unit is preferably arranged removably on the mobile evaluation unit by the user, preferably directly on the image acquisition unit. Typically, it is in this case not possible to establish reliably at which position, in particular in which detection region of the image acquisition unit, the gas-sensitive element of the detection unit is arranged. In one advantageous configuration, the detection unit therefore comprises at least one position mark in order to determine the position of the detection unit relative to the image acquisition unit when the detection unit is arranged on the mobile evaluation unit. The position of the gas-sensitive element relative to the image acquisition unit may thereby be determined straightforwardly, and therefore so can the pixels of the image acquisition unit onto which the ambient light that passes through the gas-sensitive element is focused by means of the optical lens or the plurality of optical lenses in order to image the gas-sensitive element onto the image acquisition unit.

In one advantageous configuration, the position mark is configured as a geometrical shape. The position of the gas-sensitive element may thereby be determined.

Advantageously, the position of the gas-sensitive element, particularly preferably of all gas-sensitive elements if the detection unit has several gas-sensitive elements, is specified, particularly preferably stored in the above-described data memory unit of the mobile evaluation unit. By means of the image acquisition unit, the position mark is acquired and the position of the gas-sensitive element, particularly preferably of all gas-sensitive elements if the detection unit has several gas-sensitive elements, is thereby determined. Preferably, the location and orientation (rotation) of the detection unit relative to the mobile evaluation unit is determined.

It is therefore advantageous that the position mark is configured as a geometrical figure with a rotational symmetry of less than or equal to 2, preferably without a rotational symmetry, in order to reduce, in particular prevent, any ambiguity in the determination of the location.

In one advantageous configuration, the position mark is arranged at a distance from the gas-sensitive element, in particular as a figure and/or pattern that is opaque, in particular configured to be absorbent or reflective, at least for light in the visible wavelength range, preferably in the wavelength range of from 380 nm to 780 nm.

In an alternative advantageous configuration, the position mark is integrated in the gas-sensitive element, and is particularly preferably formed from the gas-sensitive material of the gas-sensitive element.

In a further advantageous configuration, the gas-sensitive element is enclosed at least partially, preferably circumferentially, by an optically transparent region, preferably a region that is transparent in the visible wavelength range, particularly in the wavelength range of from 380 nm to 780 nm. In this advantageous configuration, the position and location, in particular rotation, of the gas-sensitive element relative to the image acquisition unit can therefore be determined by detecting the gas-sensitive element, in particular the edge or the edges of the gas-sensitive element. The transparent regions are preferably also used as a reference region for measuring an intensity variation of the ambient light and/or for a white balance, as respectively described elsewhere.

Advantageously, the gas-sensitive element is therefore configured as a position mark, particularly preferably configured with a shape that has a rotational symmetry of less than or equal to 2, preferably without a rotational symmetry, in order to reduce, in particular prevent, any ambiguity in the determination of the location.

For the detection of different target gases, it is advantageous to provide detection units comprising different gas-sensitive materials, which are suitable for detecting different target gases.

Typically, gas-sensitive materials for different target gases also have a different variation of the optical property upon contact with the target gas.

It is therefore advantageous to establish the evaluation of the data acquired by means of the image acquisition unit specifically for the gas-sensitive material respectively used.

In one advantageous configuration, the detection unit therefore comprises at least one identification mark in order to identify the detection unit by means of the image acquisition unit the detection unit arranged on the mobile evaluation unit.

By the identification of the detection unit, and correspondingly the knowledge thereby obtained about the gas-sensitive material of the detection unit arranged on the mobile evaluation unit, the evaluation of the data, which is specifically adapted for this gas-sensitive material, may take place by means of the image acquisition unit of the mobile evaluation unit.

In one advantageous development of the method according to the invention, a detection unit comprising an identification mark is therefore used. Furthermore, the detection unit is identified by means of the image acquisition unit and identification mark, and, as a function of the identification, one of several evaluation methods stored in the mobile evaluation unit is used for the analysis of the ambient light that passes through the gas-sensitive light.

Typical gas-sensitive materials already differ in their optical properties, in particular their color, in the initial state in the absence of contact with the target gas. In one economical alternative advantageous configuration, the identification of the detection unit takes place via an analysis of the ambient light that passes through the gas-sensitive element by means of the image acquisition unit. With the aid of characteristic data, in particular with the aid of specific spectral data for the different gas-sensitive materials, identification of the detection unit may thus take place without an identification mark being necessary.

In one advantageous configuration, the gas-sensitive element is configured as an identification mark. For this purpose, the gas-sensitive element has a specific shape, which is detected by means of the image acquisition unit in order to identify the detection unit. In particular, several detection units comprising gas-sensitive elements for different target gases may differ from one another in that, in one advantageous configuration, the gas-sensitive elements have different shapes.

The identification mark is preferably configured as a character code, particularly preferably as an optoelectronically readable script, preferably as a barcode or two-dimensional code (matrix barcode), in particular a QR code or data matrix code.

Because of the use of ambient light as the light source, there are typically measurement conditions with a different luminous intensity and different spectra of the light that passes through the detection unit.

In one advantageous configuration, the detection unit therefore comprises at least one reference region that is not gas-sensitive for the target gas and is arranged in such a way that the ambient light that passes through the reference region can be imaged by means of the optical lens or a further optical lens of the detection unit, in particular so that the detection unit arranged on the mobile evaluation unit can be imaged onto the image acquisition unit.

This offers the advantage that the ambient light passing through the reference region can be acquired separately by means of the image acquisition unit, and the intensity and/or the spectrum of the ambient light can be deduced by evaluating these image data and these data are used in the evaluation of the image data that are associated with the ambient light that passes through the gas-sensitive element.

In this case, it is particularly advantageous that the optical properties of the reference region correspond substantially to the optical properties of the gas-sensitive element in the absence of contact with the target gas. In this way, a comparison of the data of the ambient light that passes through the reference region, which are ascertained by means of the image acquisition unit, with the ambient light that passes through the gas-sensitive element is straightforwardly possible, and a deviation that indicates a variation of the optical properties of the gas-sensitive element and therefore a presence of the target gas can be straightforwardly detected.

In one advantageous development of the method according to the invention, a detection unit comprising a reference region that is not gas-sensitive for the target gas is therefore used, and ambient light that passes through the reference region is analyzed by means of the image acquisition unit.

In an alternative advantageous configuration, the reference region is configured to be optically transparent, preferably configured to be transparent in the visible wavelength range, particularly in the wavelength range of from 380 nm to 780 nm. In this configuration, an intensity variation of the ambient light that passes through the reference region is also acquired and taken into account in the evaluation as before. Preferably, the intensity of the ambient light that passes through the reference region and is acquired by means of the image acquisition unit, is therefore additionally acquired and a ratio is formed, in the present case as the quotient of this reference intensity to the light intensity of the ambient light that passes through the gas-sensitive element. Erroneous detections in the event of a varying intensity of the ambient light may be avoided by taking this reference intensity into account.

In one advantageous development, the ambient light that passes through the reference region is additionally used for a white balance, as described further below.

In order to increase the accuracy when acquiring a color variation of the gas-sensitive element by means of the image acquisition unit, it is advantageous to carry out a color calibration, preferably before method step B. Advantageously, the detection unit therefore has a calibration scale that comprises several colored areas, particularly preferably a calibrated color pattern, preferably an RGB or CMYK color scale. The ambient light that passes through the calibration scale is acquired by means of the image acquisition unit. The calibration data, in particular the color data of the calibration scale, are furthermore predefined, in particular stored in a memory unit of the mobile evaluation unit. A color calibration of the image acquisition unit is carried out by means of these data, preferably before carrying out the gas detection.

Advantageously, the detection unit comprises a flexible film as the carrier substrate and the gas-sensitive element and the optical lens are formed in the carrier substrate and/or arranged on the carrier substrate. This enables simple handling of the detection unit.

It is within the scope of the invention that the gas-sensitive material of the gas-sensitive element is arranged on the carrier substrate, preferably on the front side of the carrier substrate that faces away from the detection unit of the evaluation unit, which is arranged on the mobile evaluation unit.

It is within the scope of the invention that the optical lens is arranged on an opposite side of the carrier substrate from the gas-sensitive element.

In one advantageous configuration, the optical lens and the gas-sensitive element are arranged on a common side of the carrier substrate. In particular, it is advantageous that the optical lens is arranged between the gas-sensitive element and the carrier substrate. In this way, direct contact between the optical lens and the mobile evaluation unit is not necessary.

It is likewise within the scope of the invention that the gas-sensitive element is formed in the carrier substrate by the gas-sensitive material being embedded into the carrier substrate. This provides a robust structure.

In a further advantageous configuration, the optical lens is formed in the carrier substrate. It is within the scope of the invention that the optical lens is formed in the carrier substrate by modifying the refractive index. It is likewise within the scope of the invention that the optical lens is formed by embossing or stamping.

In one advantageous configuration, the optical lens is configured as a Fresnel lens. This enables economical production and a small overall thickness of the detection unit.

Advantageously, the carrier substrate comprises an adhesive layer in order to arrange the detection unit removably on the mobile evaluation unit. This ensures simple handling for the user. For residue-free removable arrangement of the carrier substrate on the mobile evaluation unit, an adhesive based on rubber or acrylate is preferably used as the adhesive.

It is within the scope of the invention that the detection unit has precisely one gas-sensitive element comprising precisely one gas-sensitive material. In this way, the detection of a target gas may take place economically.

It is within the scope of the invention that the detection unit has a plurality of gas-sensitive elements lying next to one another. In one advantageous configuration, these gas-sensitive elements comprise the same gas-sensitive material. In this way, redundant measurements may be carried out in order to increase the accuracy of the measurement.

In a further advantageous configuration, the detection unit has a plurality of gas-sensitive elements lying next to one another and comprising different gas-sensitive materials, so that several target gases can be detected without the detection unit having to be replaced.

The present invention furthermore enables the economical provision of a system which is suitable for detecting different target gases:

The system according to the invention for detecting a plurality of different target gases has a plurality of detection units according to the invention, in particular according to an advantageous configuration, each detection unit being configured to detect a different target gas than the other detection units and comprising a different identification mark and/or a different reference region than the other detection units.

The system furthermore has a mobile evaluation unit comprising an image acquisition unit, in particular a cellphone or a tablet computer, the mobile evaluation unit being configured to identify the detection unit as a function of the optical data of the identification mark and/or of the reference region of the detection unit that are acquired by means of the image acquisition unit.

The user may thus select the corresponding detection unit according to the desired target gas and arrange it on the mobile evaluation unit. With the aid of the identification mark of the detection unit and/or of the reference region, the mobile evaluation unit automatically identifies the detection unit arranged on the evaluation unit and correspondingly selects the appropriate evaluation of the image data, ascertained by means of the image acquisition unit, of the ambient light that passes through the gas-sensitive element of the detection unit.

Advantageously, a plurality of evaluation methods are therefore stored in a data memory of the mobile evaluation unit and a selection of the evaluation method for detecting a target gas takes place as a function of the identification of the detection unit.

It is in this case within the scope of the invention that the evaluation methods for different target gases differ merely in parameters of the evaluation method that are specific for a respective target gas. It is likewise within the scope of the invention to provide different evaluation methods, having different evaluation steps, for different target gases.

In one advantageous configuration of the method according to the invention, the position of the gas-sensitive element relative to the image acquisition unit is determined in order to localize an analysis region of the image acquired by the image acquisition unit, on which the ambient light that passes through the gas-sensitive element is incident. As described above, this ensures that only the relevant regions, in particular the relevant pixels, of the image acquisition unit on which the ambient light passing through the gas-sensitive element is incident are used for the detection of the target gas.

Advantageously, the position of the gas-sensitive element is determined with the aid of one or more of the following features a circumferential edge of the gas-sensitive element, which has different optical properties than the gas-sensitive element;
the position of a position mark of the detection unit;
the position of a reference mark of the detection unit, in particular a reference mark configured as a color filter;
the position of an identification mark of the detection unit.

In one advantageous configuration of the method according to the invention, a white balance (AWB-automatic white balance) of the image acquisition unit takes place between method steps A and B in order to reduce the risk of erroneous detection. In particular, it is advantageous that the detection unit has at least one reference region that does not comprise a gas-sensitive element, in particular which is configured to be optically transparent at least in the visible wavelength range, preferably in the wavelength range of from 380 nm to 780 nm. The ambient light which is detected by means of the image acquisition unit and passes through the white balance region, is therefore not modified by absorption of a gas-sensitive element and is used to carry out the white balance.

Gasochromic dyes have the capability of varying their color in the visible spectral range during the reaction with a target gas. Ideally, the dye and the gas match like a “key and lock” so that only a particular gas selectively initiates the color variation. The color variation of the gas-sensitive material corresponds directly to the absorption variation of the light that passes through the gas-sensitive material, and is specific for the respective dye. This variation may be detected with the image acquisition unit of the mobile evaluation unit, in particular by means of a camera chip.

Examples of color-sensitive dyes and the detectable target gases are given in Table 1 below.

TABLE 1

| Dye | Target gas |
|---|---|
| Rhodium complex | Carbon monoxide (CO) |
| N,N,N′,N′-Tetramethyl-p- | Nitrogen dioxide (NO₂) |
| phenylenediamine | |
| Bromophenol blue | Ammonia (NH₃) |
| Molybdenum blue, which results from | Ethylene (C₂H₄) |
| the redox reaction of ethylene with | |
| ammonium molybdate | |

In order to avoid incorrect measurements, it is advantageous to carry out at least one self-test, in which at least one of the following checks is carried out, before method step B, preferably between method steps A and B:
a) Comparing the shape of the gas-sensitive element with a predefined shape, in particular comparing the contour of the gas-sensitive element with a predefined contour;
b) Comparing a predefined hue for the gas-sensitive element with the hue, detected by means of the image acquisition unit, of the ambient light that has passed through the gas-sensitive element.

Such checks make it possible to identify faulty detection units. With the aforementioned check criterion a), for example, it is possible to identify wrong detection units, as well as damaged detection units in which the gas-sensitive element is damaged and therefore has a different shape. With test criterion b), for example, it is possible to identify wrong detection units without or with unknown gas-sensitive material. It is likewise possible to identify if the detection unit used has already come into contact with the target gas and a color change has already taken place.

Preferably, a warning is emitted to the user in the event of the test criterion or criteria not being satisfied, in particular an optical and/or acoustic warning by means of a display unit and/or a loudspeaker unit of the mobile evaluation unit.

The optical lens is preferably configured as a converging lens and preferably has a focal length in the range of from 1 mm to 2 cm.

### BRIEF DESCRIPTION OF THE DRAWINGS

Further advantageous features and configurations will be explained below with the aid of exemplary embodiments and the figures, in which:

FIG. 1 shows a sectional representation of a first exemplary embodiment of a detection unit according to the invention;

FIG. 2 shows a first exemplary embodiment of a gas sensor according to the invention comprising a detection unit according to FIG. 1;

FIG. 3 shows a second exemplary embodiment of a detection unit according to the invention;

FIG. 4 shows a second exemplary embodiment of a gas sensor according to the invention comprising a detection unit according to FIG. 3;

FIG. 5 shows a third exemplary embodiment of a detection unit according to the invention in a sectional representation;

FIG. 6 shows a plan view from the front of the third exemplary embodiment according to FIG. 5;

FIG. 7 shows a plan view from the rear of the third exemplary embodiment according to FIG. 5; and

FIG. 8 shows a further exemplary embodiment of a gas sensor according to the invention comprising a detection unit that has a gas-sensitive element configured as an identification and position mark.

### DETAILED DESCRIPTION

All the figures show schematic representations that are not true to scale. Reference signs that are the same in the figures denote elements that are the same or have the same effect.

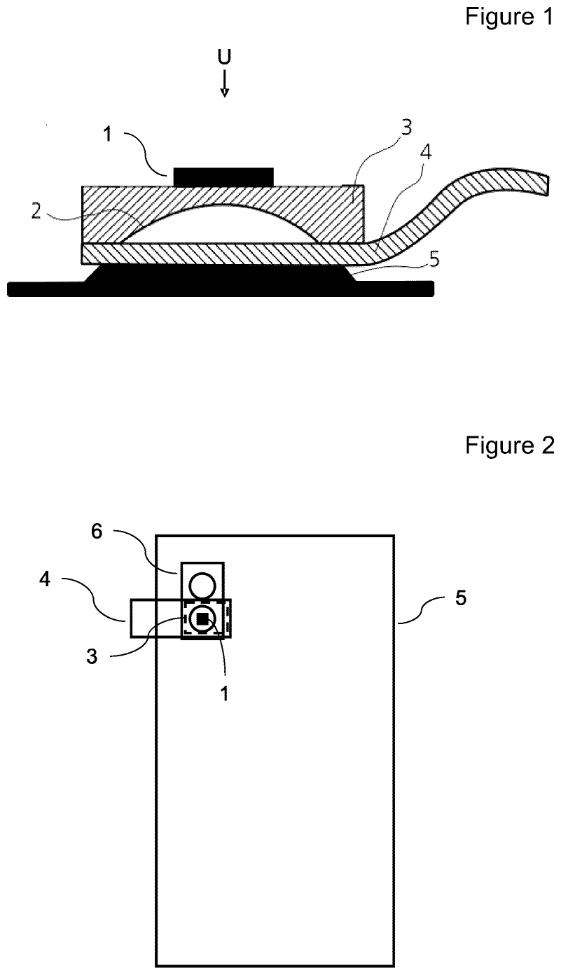

FIG. 1 shows a first exemplary embodiment of a detection unit according to the invention for a gas sensor.

The detection unit has a gas-sensitive element 1 comprising a gas-sensitive material. The gas-sensitive element is configured in a manner known per se as a gasochromic layer, so that the optical absorption properties vary as a function of the contact with a target gas. In the present case, the gas-sensitive material of the gas-sensitive element is formed as bromophenol blue in order to detect ammonia (NH₃) as the target gas.

Examples of alternative configurations with alternative dyes and the target gases that can be detected with them are given in the aforementioned Table 1.

The detection unit comprises an optical lens 2 configured as a converging lens, which is arranged on an optically transparent lens carrier element 3. The optical lens and the lens carrier element 3 are formed in the present case from polymers.

The gas-sensitive element 3 is arranged on the lens carrier element 3.

The detection unit is configured for removable arrangement on a mobile evaluation unit comprising an image acquisition unit, in order to form a gas sensor.

For this purpose, the detection unit according to the first exemplary embodiment comprises a carrier substrate 4 configured as a flexible film, which is optically transparent and is formed from polymers.

The gas-sensitive element 1 and the optical lens 2 are arranged in such a way that the ambient light that passes through the gas-sensitive element 1 is focused by means of the optical lens 2.

FIG. 1 schematically represents a subregion of a mobile evaluation unit 5, which in the present case is configured as a cellphone, comprising an image acquisition unit.

By means of the carrier substrate 4, the detection unit is arranged on the mobile evaluation unit so that the ambient light that passes through the gas-sensitive element 1 can be imaged by means of the optical lens 2 onto the image acquisition unit of the mobile evaluation unit 5, as explained in more detail below in FIG. 2.

Because of the low weight of the detection unit, there is already a sufficient grip on the mobile evaluation unit by the air pressure of the surroundings.

In one development of the first exemplary embodiment, the carrier substrate 4 is configured as an adhesion film in order to achieve a better grip.

In an alternative development, the carrier substrate 4 has in the present case an adhesive layer based on rubber on the side facing away from the optical lens 2 in order to arrange the detection unit removably on the mobile evaluation unit. In an alternative configuration, the adhesive layer is one or adhesive layers based on acrylate. The use of other adhesive layers also lies within the scope of the invention.

FIG. 2 represents an exemplary embodiment of a gas sensor according to the invention. The gas sensor has the detection unit shown in FIG. 1 according to the first exemplary embodiment and a mobile evaluation unit comprising an image acquisition unit, which in the present case is configured as a cellphone. In an alternative configuration, the mobile evaluation unit is configured as a tablet computer.

The image acquisition unit 6 of the mobile evaluation unit 5 comprises a first camera shown at the top in FIG. 2 and an underlying second camera for the usual color spectrum in the visible range for taking photographs. The detection unit in the present case is arranged on one of the two cameras, in the present case on the lower camera of the image acquisition unit 6 of the mobile evaluation unit 5, in order to detect a color change of the gas-sensitive element 1 of the detection unit by means of this camera.

The edges of the lens carrier element 3 are represented by dashes.

The ambient light passes through both the gas-sensitive element 1 and the region enclosing the gas-sensitive element 1, and is focused by means of the optical lens 2 onto the image acquisition unit 6 of the mobile evaluation unit 5 so that the gas-sensitive element is imaged onto the image acquisition unit 6.

The mobile evaluation unit 5 comprises a computing unit and a data memory unit. An evaluation program is stored in the data memory unit in order to analyze the image data of the image acquisition unit 6 by means of the computer unit.

Even if there is no contact between a target gas and the gas-sensitive element 1, the position of the gas-sensitive element can be ascertained by means of analyzing the position-resolved image data of the image acquisition unit 6, since the gas-sensitive element has an absorption and therefore a characteristic color even in the absence of contact with the target gas and can therefore be localized in the image data of the image acquisition unit 6, for example by filtering over pixels with the corresponding color values.

During the evaluation, a localization of those pixels which acquire ambient light that passes through the gas-sensitive element initially takes place as described above.

Since the gas-sensitive material used and its optical properties are known, a color spectrum that corresponds to the color of the gas-sensitive element upon contact with the target gas is furthermore predefined in the evaluation program.

By means of the evaluation program, whether a color change takes place in the predefined spectrum at the pixels of the image acquisition unit 6 that are assigned to the gas-sensitive element is then repeatedly checked. If there is a color change, a warning message that the target gas has been detected is emitted to the user on a display unit of the mobile evaluation unit 5, which is arranged on the opposite side of the mobile evaluation unit 5 from the image acquisition unit 6.

In an alternative configuration, the light intensity is used by means of the evaluation program and the image acquisition unit 6 only as an indicator in order to detect a variation of the optical properties of the gas-sensitive element and therefore a presence of the target gas. With such an evaluation, the risk exists that a variation of the intensity of the ambient light leads to an erroneous detection. In one development of the exemplary embodiment, the intensity of the ambient light acquired by means of the image acquisition unit 6, which does not pass through the gas-sensitive element, is therefore additionally acquired and a ratio is formed, in the present case as the quotient of this reference intensity to the light intensity of the ambient light that passes through the gas-sensitive element. Erroneous detections in the event of a varying intensity of the ambient light may be avoided by taking this reference intensity into account.

In a variant of the exemplary embodiment represented in FIG. 1, several gas-sensitive elements are arranged on the upper-lying side of the lens carrier element 3 in FIG. 1, in particular a matrix comprising a multiplicity of gas-sensitive elements, in the present case a 5×5 matrix therefore comprising a total of 25 gas-sensitive elements, is preferably formed. The gas-sensitive elements have different gas-sensitive materials than one another, so that detection of a multiplicity of target gases is possible.

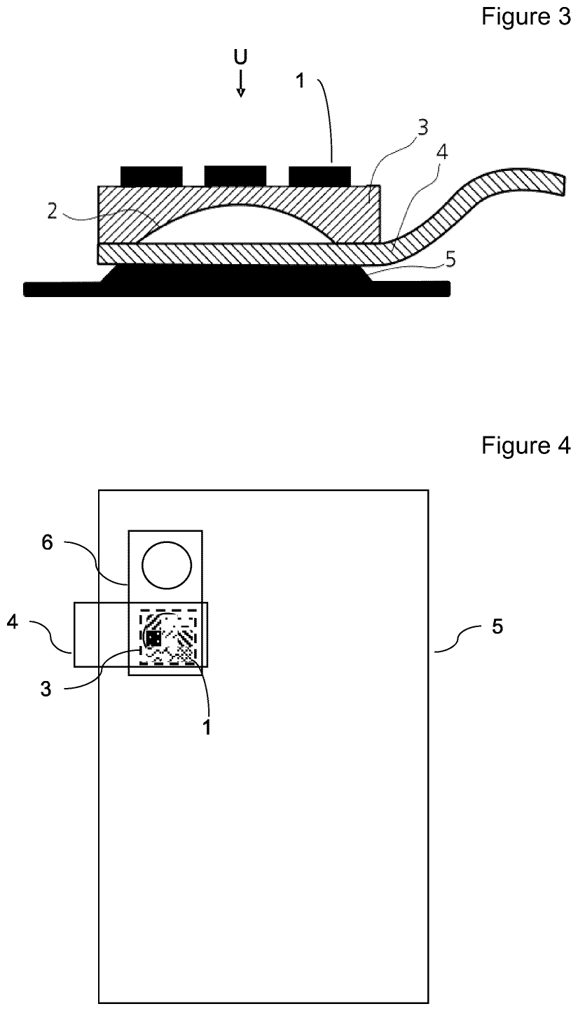

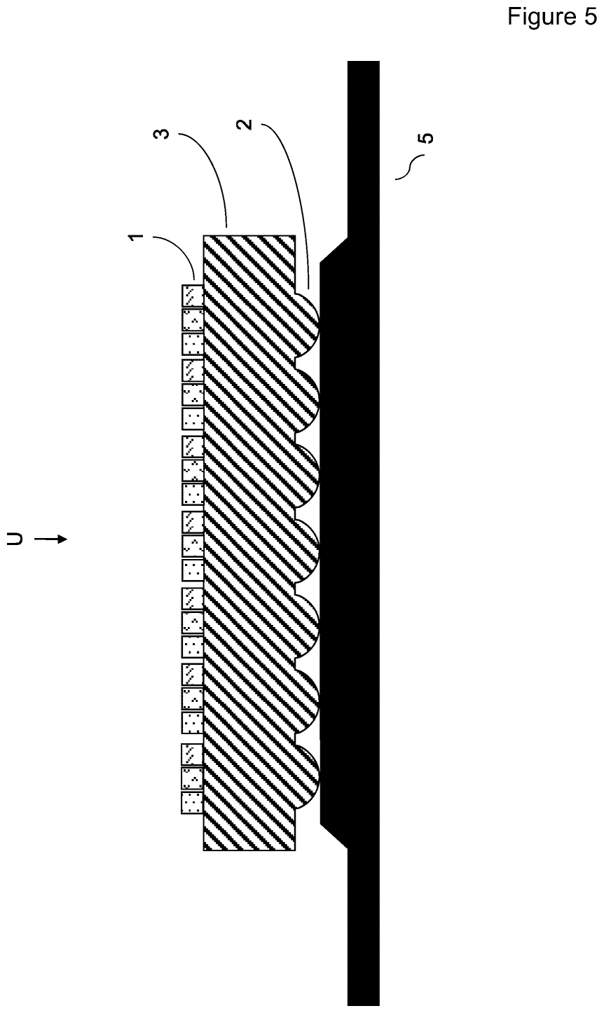

FIG. 3 shows a second exemplary embodiment of a detection unit according to the invention in a sectional representation. FIG. 4 shows a second exemplary embodiment of a gas sensor according to the invention comprising a detection unit according to FIG. 3. The two exemplary embodiments of a detection unit and gas sensor are constructed in substantially the same way as the first exemplary embodiments according to FIGS. 1 and 2. In order to avoid repetitions, the essential differences will be discussed below.

The detection unit according to the second exemplary embodiment has in total nine gas-sensitive elements comprising different gas-sensitive materials, so that 9 different target gases can be detected. The nine gas-sensitive elements are arranged in a square 3×3 matrix on the lens carrier element 3. In the sectional representation according to FIG. 3, therefore, 3 gas-sensitive elements can be seen, the gas-sensitive element lying on the right being denoted by way of example with the reference sign 1. In a variant of the second exemplary embodiment, it comprises only 3 different gas-sensitive materials, 3 gas-sensitive elements in each case comprising the same gas-sensitive material. In this variant, 3 different target gases can therefore be detected and there is furthermore a redundancy in the measurements, so that the measurement accuracy is improved.

In the plan view from above shown in FIG. 4, likewise as in FIG. 2, a border of the lens carrier element 3 is represented by a dashed line. The 9 gas-sensitive elements are characterized by different hatchings. The 9 gas-sensitive elements are arranged at a distance from one another so that ambient light passing through the detection unit between the gas-sensitive elements is not absorbed, or is absorbed only to a small extent, and is not modified in its spectrum.

The rectangular grid formed by the distances between the gas-sensitive elements can therefore be detected by means of the image sensor 6a of the image acquisition unit 6. The position of the detection unit relative to the mobile evaluation unit 5 can be deduced with the aid of the location of the rectangular grid. In particular, whether all 9 fields of the rectangular grid are acquired by means of the image acquisition unit 6 is checked. If this is not the case, an error message is emitted to the user via the optical display of the mobile evaluation unit 5 so that they can position the detection unit correctly.

FIG. 5 shows a third exemplary embodiment of a detection unit according to the invention in a sectional representation. The detection unit comprises a matrix of in total 49 detection fields, which are arranged in a square 7×7 matrix. Each detection field comprises 9 gas-sensitive elements, which are arranged in a square 3×3 matrix as described in the 2^{nd} exemplary embodiment with reference to FIGS. 3 and 4.

The third exemplary embodiment shown in FIG. 5 therefore has a large number of gas-sensitive elements, there being a high redundancy of the detection for each of the 9 target gases since 49 detection units are respectively arranged on the lens carrier element 3 for each of the 9 target gases.

In contrast to the 1^{st} and 2^{nd} exemplary embodiments of a detection unit, the detection unit represented in FIG. 5 comprises a plurality of optical lenses, which are formed from the material of the lens carrier element 3 and are arranged as hemispherical projections on the opposite side of the lens carrier element 3 from the gas-sensitive elements. By way of example, the optical lens lying on the right in FIG. 5 is denoted by the reference sign 2. One optical lens is formed for each detection field, so that the optical lenses are correspondingly also arranged in a square 7×7 matrix.

The optical lenses 2 comprise an adhesive layer in order to arrange the detection unit on the mobile evaluation unit 5. For illustration, FIG. 5 represents a partial detail of the image acquisition unit 6 of the mobile evaluation unit 5. In the present case, the mobile evaluation unit 5 is configured as a tablet computer.

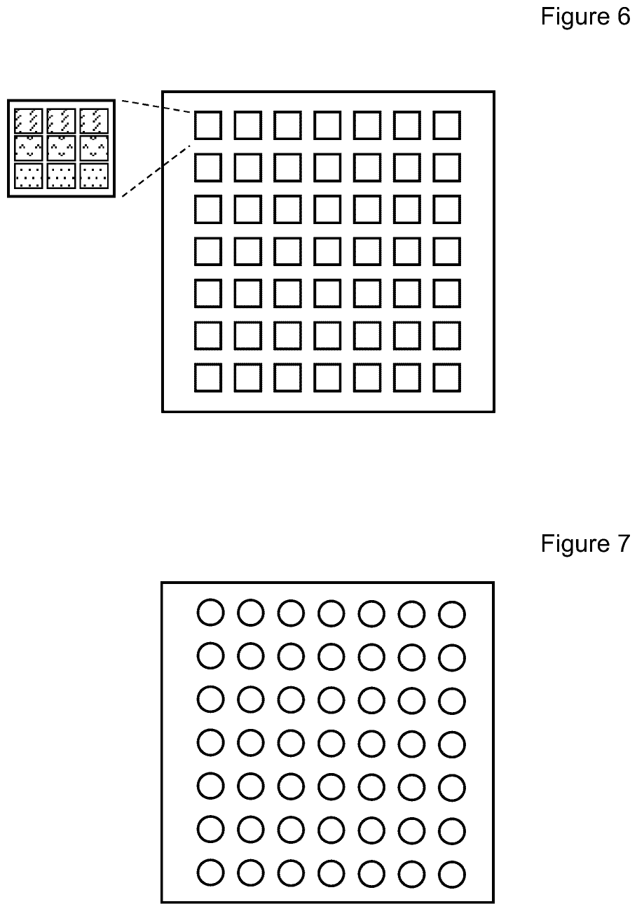

FIG. 6 represents a plan view of the detection unit shown in FIG. 5, the detection fields arranged in the 7×7 matrix being represented schematically as squares. The detection field at the top left is shown with a detail enlargement, the individual gas-sensitive elements, which are arranged in a 3×3 matrix, being visible in the detail enlargement.

FIG. 7 shows a plan view of the rear side of the detection unit shown in FIG. 5, the optical converging lenses, which are arranged in a 7×7 matrix, respectively being schematically represented as circles.

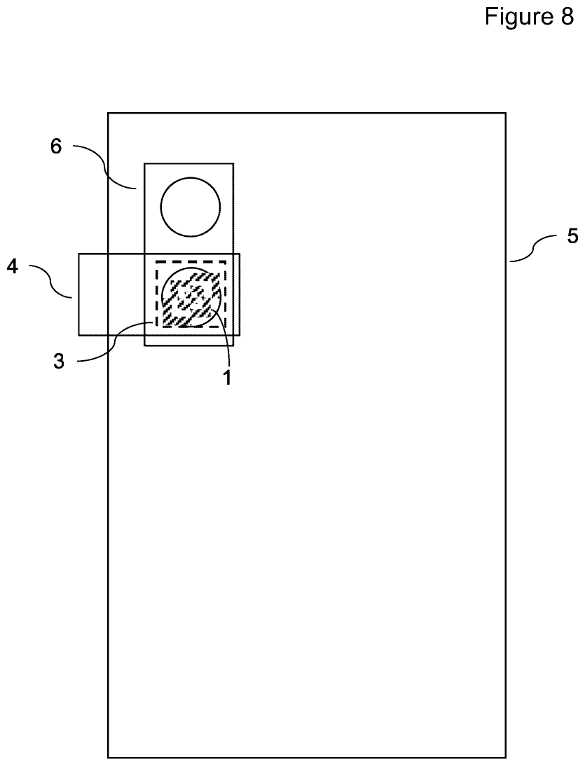

FIG. 8 represents a further exemplary embodiment of a gas sensor according to the invention comprising a further exemplary embodiment of a detection unit according to the invention. The structure is substantially the same as the structure shown in FIG. 2, with a mobile evaluation unit 5 that comprises the image acquisition unit 6, on which the detection unit comprising a carrier substrate 4 and a lens carrier element 3, denoted by dashed lines, and a gas-sensitive element 1 are arranged.

An essential difference from the first exemplary embodiment represented in FIGS. 1 and 2 is that the gas-sensitive element 1 is configured as a geometrical figure and therefore constitutes both a position mark and an identification mark.

The gas-sensitive element comprises a plurality of angular elements. The position of the angle elements is acquired by means of the image sensor so that the position and rotation of the gas-sensitive element relative to the image sensor can be acquired. Furthermore, the detection unit can be distinguished from other detection units that comprise a gas-sensitive element, the shape and/or individual elements of which are configured differently than that shown in FIG. 8. The user can therefore be provided with a plurality of detection units which comprise different gas-sensitive dyes and are therefore suitable for the detection of different target gases.

The detection unit is identified with the aid of the shape of the gas-sensitive element, so that the evaluation takes place specifically for the gas-sensitive element applied on the mobile evaluation unit, and the target gas detected by this gas-sensitive detection unit can be displayed in plain text to the user on an optical display of the mobile evaluation unit 5.

The gaps between the angular elements of the gas-sensitive element are optically transparent for light in the visible range, so that the intensity of the ambient light can be measured by means of the pixels of the image sensor of the image acquisition unit 6 which acquire ambient light that passes through these gaps, and a fluctuation in the intensity of the ambient light can be taken into account as described above by forming the quotient during the evaluation.

### LIST OF REFERENCE SIGNS

1 gas-sensitive element
2 optical lens
3 lens carrier element
4 carrier substrate
5 mobile evaluation unit
6 image acquisition unit
6a image sensor
7 adhesive element
U ambient light

1. A detection unit for a gas sensor, the detection unit comprising:
at least one gas-sensitive element (1) comprising at least one gas-sensitive material, optical properties of which vary as a function of contact with a target gas,
the detection unit is configured for removable arrangement on a mobile evaluation unit (5) comprising an image acquisition unit (6), in order to form a gas sensor,
at least one optical lens (2), and the gas-sensitive element (1) and the optical lens (2) are arranged such that ambient light that passes through the gas-sensitive element (1) is adapted to be imaged by the optical lens (2) onto the image acquisition unit (6) when the detection unit is arranged on the mobile evaluation unit (5).

2. The detection unit as claimed in claim 1, wherein
the detection unit comprises a plurality of the optical lenses (2) that are arranged in a lens matrix in order to image a two-dimensional region in a plurality of focusing beams, to image a plurality of focusing beams onto a plurality of differently positioned points of the image acquisition unit (6) when the detection unit is arranged on the mobile evaluation unit (5).

3. The detection unit as claimed in claim 1, further comprising
at least one position mark in order to determine a position of the detection unit relative to the image acquisition unit (6) when the detection unit is arranged on the mobile evaluation unit (5),
wherein the gas-sensitive element is configured as the position mark.

4. The detection unit as claimed in claim 1, further comprising:
at least one identification mark in order to identify the detection unit by the image acquisition unit (6) when the detection unit is arranged on the mobile evaluation unit (5),
wherein the gas-sensitive element is configured as the identification mark.

5. The detection unit as claimed in claim 1, further comprising
at least one reference region that is not gas-sensitive for the target gas, which is arranged such that the ambient light that passes through the reference region is adapted to be imaged by the optical lens (2) or a further optical lens (2) of the detection unit, onto the image acquisition unit (6) when the detection unit is arranged on the mobile evaluation unit (5).

6. The detection unit as claimed in claim 1, further comprising
a flexible film as the carrier substrate (4), and the gas-sensitive element (1) and the optical lens (2) are at least one of formed in the carrier substrate (4) or arranged on the carrier substrate (4).

7. The detection unit as claimed in claim 6, wherein
the carrier substrate (4) comprises an adhesive layer in order to arrange the detection unit removably on the mobile evaluation unit (5).

8. A gas sensor,
having the detection unit as claimed in claim 1 and a mobile evaluation unit (5) comprising an image acquisition unit (6), and the mobile evaluation unit (5) is configured as a cellphone or tablet computer.

9. A system for detecting a plurality of different target gases,
having a plurality of the detection units as claimed in claim 1, each said detection unit being configured to detect a different target gas than the other detection units and comprising at least one of a different identification mark or different reference region than the other detection units,
and a mobile evaluation unit (5) comprising an image acquisition unit (6), the mobile evaluation unit (5) being configured to identify the detection unit as a function of optical data of the at least one of the identification mark or of the reference region of the detection unit acquired by the image acquisition unit (6).

10. A method for detecting a target gas,
comprising the method steps of:
A. arranging the detection unit as claimed in claim 1 on a mobile evaluation unit (5) comprising an image acquisition unit (6);
B. analyzing the ambient light that passes through the gas-sensitive element (1) of the detection unit by the image acquisition unit (6) in order to detect the target gas; and
C. removing the detection unit from the mobile evaluation unit (5).

11. The method as claimed in claim 10, further comprising
determining a position of the gas-sensitive element (1) relative to the image acquisition unit (6) in order to localize an analysis region of the image acquired by the image acquisition unit (6), on which the ambient light that passes through the gas-sensitive element (1) is incident,
including determining the position of the gas-sensitive element (1) with the aid of one or more of the following features
a circumferential edge of the gas-sensitive element (1), which has different optical properties than the gas-sensitive element (1);
a position of a position mark of the detection unit;
a position of a reference mark of the detection unit;
a position of an identification mark of the detection unit.

12. The method as claimed in claim 10, wherein
one said detection unit comprising a reference region that is not gas-sensitive for the target gas is used, and ambient light that passes through the reference region is analyzed by the image acquisition unit (6).

13. The method as claimed in claim 10, wherein
one said detection unit comprising an identification mark is used,
and the detection unit is identified by the image acquisition unit (6) and the identification mark and, as a function of the identification, one of several evaluation methods stored in the mobile evaluation unit is used for the analysis of the ambient light that passes through the gas-sensitive element (1).

14. The method as claimed in claim 10, further comprising carrying out
a white balance of the image acquisition unit (6) between method steps A and B.

15. The method as claimed in claim 10, further comprising
carrying out at least one self-test, in which at least one of the following checks is carried out, before method step B:
A. comparing a shape of the gas-sensitive element with a predefined shape;
B. comparing a predefined hue for the gas-sensitive element with a hue, detected by of the image acquisition unit, of the ambient light that has passed through the gas-sensitive element.

16. The detection unit as claimed in claim 5, wherein optical properties of the reference region correspond substantially to optical properties of the gas-sensitive element (1) in an absence of contact with the target gas.

17. The system of claim 9, wherein a plurality of evaluation methods are stored in a data memory of the mobile evaluation unit (5) and a selection of the evaluation method for detecting the target gas takes place as a function of the identification of the detection unit.
